(19) United States
(12) Patent Application Publication
(10) Pub. No.: US 2026/0120528 A1
(43) Pub. Date: Apr. 30, 2026

(54) Method For Determining A Surface Regeneration Parameter Of A Contact Surface Of A Contactor, Method For Determining An Ageing Factor Of A Contact Surface Of A Contactor Taking Into Account A Surface Regeneration Parameter, And Method For Regenerating A Contact Surface Of A Contactor

(71) Applicant: Vitesco Technologies GmbH, Regensburg (DE)

(72) Inventor: Christian Reichinger, Neutraubling (DE)

(73) Assignee: Vitesco Technologies GmbH, Regensburg (DE)

(21) Appl. No.: 18/959,507

(22) Filed: Nov. 25, 2024

Related U.S. Application Data
(63) Continuation of application No. PCT/EP2023/063805, filed on May 23, 2023.

(30) Foreign Application Priority Data
May 30, 2022 (DE) 10 2022 205 387.7

(51) Int. Cl. G07C 5/08; B60R 16/033

(52) U.S. Cl. CPC G07C 5/0816; B60R 16/033

(57) ABSTRACT

A method for determining a surface regeneration parameter of a contact surface of an electrical contactor, such as a contactor in a vehicle, is provided. The surface regeneration parameter is representative of a regeneration of the contact surface of the contactor taking place during a closed state of the contactor. The method includes the following steps: determining a load current flowing through the closed contactor, determining a duration in which the contactor is closed, and determining the surface regeneration parameter based on the determined load current and the determined duration.

### CROSS-REFERENCE TO RELATED APPLICATIONS

This application claims the benefit of PCT Application PCT/EP2023/063805, filed May 23, 2023, which claims priority to German Application 10 2022 205 387.7, filed May 30, 2022. The disclosures of the above applications are incorporated herein by reference.

### TECHNICAL FIELD

The disclosure relates to a method for determining a surface regeneration parameter of a contact surface of an electrical contactor, such as a contactor in a vehicle. The disclosure furthermore relates to a method for determining an ageing factor of a contact surface of an electrical contactor, such as a contactor in a vehicle, considering a surface regeneration parameter. The disclosure furthermore relates to a method for regenerating a contact surface of an electrical contactor, such as a contactor in a vehicle, based on of a surface regeneration parameter.

### BACKGROUND

Modern vehicles have a large number of electrical connections which have or have to have so-called contactors in order to protect electrical components that are connected to these electrical connections. Contactors or also protectors in short are electrically or electromagnetically actuated or actuatable switches, which are designed in particular for high electrical powers and have two predetermined switching positions, namely an open switching position in which the electrical connection is interrupted and a closed switching position in which the electrical connection is closed, where in the case of a closed connection, the electrical connection is ultimately current-conducting or can conduct a load current.

Contactors are used, for example, to protect electrical components which are connected to the electrical connection in which the contactor is located. In contrast to other switches, such as relays, contactors are not only designed for high electrical power, but are also always double interrupting. In contrast, relays are switches which are designed for lower switching powers and are single interrupting. A further, entirely essential feature of a contactor is moreover the presence of a so-called spark extinguishing chamber, which is used to prevent the occurrence of an electric arc at the switching contacts of the contactor or to cause an occurring arc to collapse rapidly.

One example of such a contactor in a modern vehicle is, for example, a contactor in an electrical connection between an energy storage unit, such as a battery unit of a vehicle, and a charging unit for the energy storage unit of the vehicle. Such contactors are also referred to, for example, as battery contactors. Other contactors are also known, however, such as contactors between an inverter and an energy storage unit or contactors between a DC charging station and an energy storage unit.

Since contactors generally have to withstand very high electrical loads, it is not unusual for the contact surfaces of the contactor to age due to opening and closing of the contactor over the service life. For this reason, the contact surface of the contactor is generally assigned a so-called ageing factor, which is ultimately to specify an ageing status of the contact surface of the contactor.

Previous methods for determining an ageing status of a contact surface of a contactor are inaccurate or incomplete, however.

### SUMMARY

The disclosure provides a method where an ageing status of a contact surface of a contactor can be determined more accurately and completely.

According to one aspect of the disclosure, a method is provided for determining a surface regeneration parameter of a contact surface of an electrical contactor or protector, such as a contactor in a vehicle. The surface regeneration parameter is representative here of a regeneration or self-healing of the contact surface of the contactor taking place during a closed state of the contactor. The method according to the first aspect includes the following steps: determining a current or load current flowing through the closed contactor, determining a duration in which the contactor is closed, and determining a surface regeneration parameter based on the determined current and the determined duration.

Implementations of the disclosure may include one or more of the following optional features. In some implementations, the method is at least partially based on the finding that the contact surface of an electrical contactor can be regenerated under certain circumstances during the closed state of the contactor. The method is furthermore based on the finding that this regeneration takes place in dependence on a duration in which the contactor is closed and in dependence on a load current flowing through the closed contactor. The disclosure is furthermore based on the finding that a surface regeneration parameter can be specified based on the determined load current and the determined duration of the closed contactor. The actual ageing status of the contact surface of the electrical contactor can thus be quantified more accurately. This is because it is then comprehensible to what extent the contact surface regenerates in the closed state of the contactor and how this regeneration can be specified on the basis of a surface regeneration parameter.

In some implementations, the method provides that the surface regeneration parameter is determined based on a load integral of the determined load current and the determined duration. In the scope of this disclosure, the term “load integral” means an integral of the square of the electric load current I over the duration t for which the contactor is closed. The calculation of the load integral is thus similar to the calculation of the limit load integral, which is also known as the melting integral and describes, for example, a trigger behavior of a fuse.

In some implementations, the surface regeneration parameter is moreover determined in dependence on an ambient temperature of the contactor. This example is initially at least partially based on the finding that a surface regeneration of the contact surface of the contactor is not only dependent on load current and duration of the closed contactor, but also on an ambient temperature of the contactor. It has thus been established, for example, that for the same load integral of load current and duration, the surface regeneration is higher at higher ambient temperatures than at lower ambient temperatures.

The surface regeneration parameter can be determined, for example, on the basis of functional relationships between duration, load current, and optionally the ambient temperature of the contactor. These functional relationships can be provided, for example, in the form of table values or can be made available in another way for further processing. For example, to also be able to determine a so-called ageing factor of a contact surface of an electrical contactor, where the ageing factor is representative of an ageing status of a contact surface of the contactor.

A second aspect of the disclosure provides a method for determining an ageing factor of an electrical contactor in an electrical connection, such as an electrical contactor in a vehicle. The ageing factor is representative of an ageing status of a contact surface of the contactor. The ageing factor is furthermore a progressive counter, the value of which is changed in dependence on opening and closing of the contactor. The method according to the second aspect provides for determination of a differential voltage across the open contactor. The differential voltage across the open contactor is determined, for example, via two separate voltmeters across the positive and negative lines of the electrical connection, where the difference between the determined voltages represents the differential voltage of the contactor. The differential voltage is thus in particular not determined via a direct voltage measurement by means of an electrical connection across the open contactor, because this would ultimately result in a high-resistance electrical connection between the two sides of the open contactor, which is not supposed to or cannot take place, because then the current-conducting line cannot actually be interrupted by opening the contactor.

The method according to the second aspect furthermore provides for determination of a first addition element for the ageing factor based on the determined differential voltage. This can again be carried out on the basis of table values, for example.

The method according to the second aspect furthermore provides for closing of the contactor if a current ageing factor, which is calculated based on the last known ageing factor before the closing of the contactor and adding of the first addition element, is below a threshold value. In other words, the first addition element is thus added to the last current ageing factor in order to obtain the now current ageing factor. If this current ageing factor is below a threshold value, which represents an emergency operation threshold value for operating a vehicle, for example, the contactor is then closed in the method according to the second aspect. If, vice versa, however, the current ageing factor thus calculated is above this threshold value, the contactor would then not be closed.

The method according to the second aspect furthermore provides for determination of a surface regeneration parameter which is representative of the regeneration of a contact surface of the contactor while the contactor is closed, where the surface regeneration parameter is determined based on a load current flowing through the closed contactor and a duration for which the contactor is closed. The surface regeneration parameter can be determined, as was already described in conjunction with the method according to the first aspect, on the basis of table values or the like.

The method according to the second aspect furthermore provides for determination of a subtraction element for the ageing factor in dependence on the determined surface regeneration parameter. The subtraction element can in turn be determined based on table values or other functional relationships in dependence on the determined surface regeneration parameter. The subtraction element, like the first addition element as well, has a nominally positive value, but is referred to as the subtraction element since in contrast to the addition element, however, it contributes to a reduction of the ageing factor, as will be explained in more detail later.

The method according to the second aspect furthermore provides for determination of the load current on the closed contactor immediately before the opening of the contactor. The term “immediately before opening the contactor” is supposed to express that while the contactor is closed, a load current flows via the electrical connection, which is not permanently uniform, however, but is possibly reduced by an external control unit shortly before the contactor is opened, also to avoid as much as possible arcs on the contactor to be opened.

The method according to the second aspect furthermore provides for determination of a second addition element for the ageing factor based on the load current which was determined immediately before the opening of the contactor. The second addition element for the ageing factor, like the first addition element for the ageing factor as well, is nominally positive, but contributes to increasing the ageing factor, as will be shown later. The second addition element, like the first addition element and the subtraction element as well, can be determined on the basis of functional relationships or table values.

The method according to the second aspect furthermore provides for opening of the contactor and determination of a current ageing factor of the contactor after the opening of the contactor based on the last known ageing factor before the opening of the contactor and adding of the second addition element and subtracting of the subtraction element. The last known ageing factor before the opening of the contactor already took into consideration the first addition element, which is to specify the ageing of the contact surface upon closing of the contactor. By virtue of the fact that the second addition element is moreover added on after the opening of the contactor and moreover the subtraction element is subtracted, the current ageing factor thus obtained represents the ageing status of the contact surface of the contactor more accurately and completely. This is because the ageing both upon closing of the contactor (first addition element) and upon opening of the contactor (second addition element) was taken into consideration, as was the occurring regeneration or self-healing of the contact surface while the contactor is closed (subtraction element).

The method according to the second aspect thus determines the ageing factor of the electrical contactor more accurately than the known methods according to the prior art in that the surface regeneration of the contact surface(s) taking place in the closed contactor is taken into account by the subtraction element.

The method according to the second aspect uses essentially the same finding as the method according to the first aspect, namely determining the surface regeneration parameter based on the load current which flows while the contactor is closed, and based on the duration for which the contactor is closed.

One preferred embodiment of the method according to the second aspect provides that the surface regeneration parameter is determined based on a load integral of determined load current and determined duration. The load integral is again the integral of the square of the electrical load current I over the duration t in which the contactor is closed.

In some implementations, the surface regeneration parameter is determined based on an ambient temperature. The finding is again used in this case that with equal load current and equal duration, a regeneration of the contact surface is greater if the ambient temperature of the contactor is greater.

In some examples, if a short circuit takes place in an electrical connection in the vehicle while the contactor is closed, the following steps are carried out: determining the short circuit, determining a value for the limit load integral of the circuit breaker which has interrupted the short circuit, and determining a third addition element for the ageing factor based on the determined value for the limit load integral. The third addition element takes into account the additional ageing of the contact surface due to the short circuit in the electrical connection and can be determined, like the two other addition elements, by functional relationships or table values in dependence on the determined limit load integral. This example is at least partially based on the finding that a value for the limit load interval of, for example, current monitoring of a high-voltage battery can be 1.5 million A²s (ampere-squared-seconds), whereas a value for the limit load interval of, for example, the discharge of a capacitor of an EMC filter of an inverter can be 10,000 A²s (ampere-squared-seconds). The ageing factor can thus increase by different amounts depending on the value of the limit load interval.

In some implementations, a current ageing factor, taking into account the short circuit, is determined based on the last current ageing factor and adding the third addition element. Since the last known or current ageing factor, as already described, is calculated by adding on the first and second addition elements and subtracting the subjection element, in this example, the third addition element, which is to represent ageing of the contact surface taking place due to the short circuit, is now finally added on. The current ageing factor therefore results by addition of all three addition elements and subtraction of the subtraction element.

In some examples, if the ageing factor exceeds a warning threshold value, which is below an emergency operation threshold value, after the adding of the first addition element, a communication about a vehicle repair shop visit for surface regeneration takes place, for example, to the driver of the vehicle. This example is at least partially based on the finding that if a threshold value which is above a warning threshold value but below an emergency operation threshold value is exceeded, the contact surface of the contactor can be regenerated appropriately, for example, by a repair shop visit.

A third aspect of the disclosure provides a method for regenerating a contact surface of an electrical contactor, such as a contactor in a vehicle. The method according to the third aspect includes the following steps: determining that a regeneration of the contact surface is required and regenerating the contact surface by way of closing the contactor for a duration which is required for the regeneration. The method according to the third aspect also uses the finding that the contact surface of the electrical contactor can be regenerated by the closed contactor and the load currents linked thereto during a suitable duration in which the contactor is closed.

In some implementations, a load current flowing through the closed contactor is determined and the duration required for the regeneration is determined on the basis of the determined load current.

In some examples, the contactor is in an electrical connection between an energy storage unit of a vehicle and a charging unit, such as a DC/DC charging unit, for the energy storage unit and the regeneration of the contact surface upon closing of the contactor is carried out by starting the charging process of the energy storage unit.

In some implementations, a communication is issued according to which the state of charge of the energy storage unit is to be adapted accordingly if the duration of the charging process required for the regeneration is greater than a current maximum possible charging duration, which is determined in dependence on a current state of charge of the energy storage unit. In other words, it is conceivable that a regeneration of the contact surface of the contactor is necessary, but the charging duration required for the regeneration is greater than a current maximum possible charging duration, since the energy storage unit is still too full at the time at which the regeneration would be necessary, for example, and thus cannot be charged over the entire required duration which would be necessary for the regeneration of the contact surface. The communication which is output in this case states, for example, that the driver of the vehicle or some third party still has to empty the energy storage unit by a predetermined value, for example by traveling a minimum distance without charging the vehicle. The next charging process would then take place in the repair shop, in which the vehicle can now be charged for the charging duration required for the regeneration due to the additionally emptied energy storage unit.

Examples and implementations of the method according to the first aspect are also examples and implementations of the method according to the second aspect and/or according to the third aspect, and vice versa.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an electrical connection having an electrical contactor.

FIG. 2 shows a schematic view of a flow chart for carrying out a method according to a first aspect of the disclosure.

FIG. 3 shows a schematic view of a flow chart for carrying out a method according to a second aspect of the disclosure.

FIG. 4 shows a schematic view of a flow chart for carrying out a method according to FIG. 3.

FIG. 5 shows a schematic view of a flow chart for carrying out a further method according to FIG. 3.

FIG. 6 shows a schematic view of a flow chart for carrying out a method according to a third aspect.

FIG. 7 shows a schematic view of a flow chart for carrying out a method according to FIG. 6.

Like reference symbols in the various drawings indicate like elements.

### DETAILED DESCRIPTION

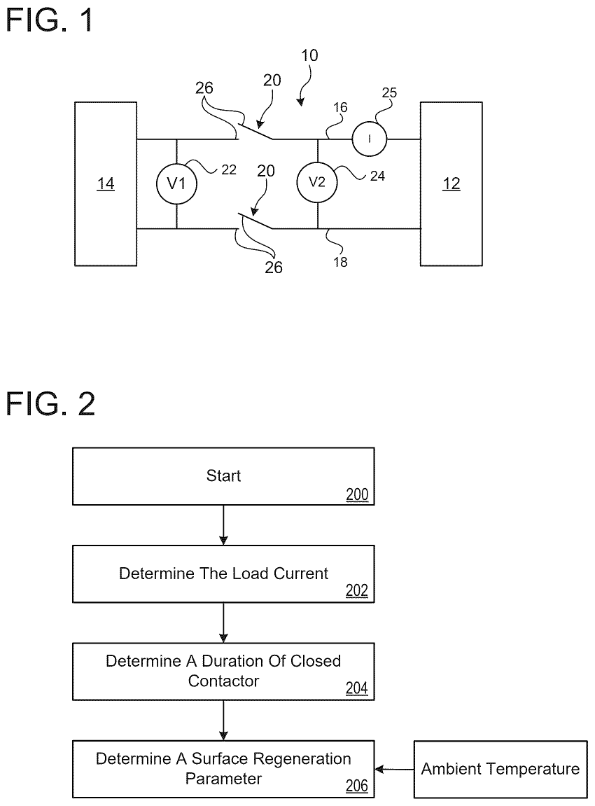

Reference is first made to FIG. 1, which shows an electrical connection 10 between an energy storage unit 12 and a charging unit 14 for the energy storage unit 12. In the specific example of FIG. 1, the electrical connection 10 is an electrical connection in a vehicle, but it can also be another electrical connection in other embodiments (not shown). The energy storage unit 12 can be, for example, a battery unit for a battery-operated vehicle. The energy storage unit 12 can however also be another energy storage unit as would be present, for example, in a fuel-cell-operated vehicle. The charging unit 14 can be a charging column for charging the energy storage unit 12, such as a DC/DC charging column. The charging unit 14 can also be an inverter unit of an onboard charging unit of a vehicle. It is essential that the charging unit 14 can be used for charging the energy storage unit 12.

As is typical for such electrical connections, the electrical connection 10 between the charging unit 14 and energy storage unit 12 has two electrical lines 16, 18, wherein one of the two lines 16, 18 connects the two positive poles of charging unit 14 and energy storage unit 12 and the other of the two lines 16, 18 connects the two negative poles of charging unit 14 and energy storage unit 12.

A so-called contactor or protector 20 in short is arranged in each of the two electrical lines 16, 18. The contactor 20 is an electrically or electromagnetically actuated or actuatable switch, which is designed for high electrical powers and has two predetermined switching positions. In a first, open switching position of the contactor 20, which is shown in FIG. 1, the respective electrical line 16, 18 is interrupted, so that current cannot flow between the charging unit 14 and the energy storage unit 12. In a second, closed switching position of the contactor 20 (not shown in FIG. 1), the respective electrical line 16, 18 is closed, so that current, such as load current, can flow between the charging unit 14 and the energy storage unit 12.

As is furthermore shown in FIG. 1, there is a first voltmeter 22 between the lines 16, 18 and a second voltmeter 24 between the lines 16, 18. The two voltmeters 22, 24 are arranged on opposite sides of the contactor 20. By way of the voltmeters 22, 24, a voltage difference between the lines 16, 18 can be measured upstream and downstream of the contactor 20. By comparing the two measured voltage differences, a differential voltage across the open contactor 20 can be determined, as is known to a person skilled in the art in the case of such arrangements.

As is furthermore shown in FIG. 1, there is also an ammeter 25. With the aid of the ammeter 25, it is possible to measure the load current flowing across the closed contactor 20 between the units 12 and 14.

The contactor 20 has one or more contact surfaces 26, which mutually contact in the closed state of the contactor 20 in a current-conducting and voltage-conducting manner, so that in the closed state of the contactor 20, load current can ultimately flow between the units 12 and 14 via the lines 16, 18. As already mentioned in the introduction, the contact surface 26 of the contactor 20 is subject to material-related ageing. The ageing of the contact surface 26 can occur due to the high electrical powers which the contactor 20 has to conduct. However, as has already been mentioned multiple times in the scope of this disclosure, it is entirely possible that the contact surface 26 can be subject to self-healing in the closed state of the contactor 20, so that possibly occurring ageing of the contact surface 26 can be partially or even completely compensated for.

FIGS. 2 to 7, show methods to determine a regeneration of the contact surface 26 of the contactor 20 in the closed state of the contactor 20 and to map this regeneration by way of a so-called surface regeneration parameter. The surface regeneration parameter can then be taken into account, for example, in the determination of an ageing factor of the contact surface 26, which reflects the current ageing state of the contact surface 26, in order to determine a more accurate current ageing state of the contact surface 26 adjusted by the regeneration.

Reference is made to FIG. 2, which shows a flow chart for carrying out a method for determining a surface regeneration parameter of the contact surface 26 of the electrical contactor 20, where the contactor 20 is arranged, for example, in an electrical connection 10 as was shown in conjunction with FIG. 1.

The method starts with step 200.

In step 202, the method determines the load current which flows between the two units 12, 14 when the contactor 20 is closed. This is performed by the ammeter 25.

In step 204, the method furthermore determines a duration for which the contactor 20 is closed.

Based on the determined duration for which the contactor 20 is closed and based on the determined load current when the contactor 20 is closed, a surface regeneration parameter is determined in step 206. The surface regeneration parameter can be determined, for example, based on the load integral of determined duration and determined load current and can be provided, for example, via functional relationships or table values. The surface regeneration parameter is optionally moreover determined taking into account an ambient temperature of the contactor 20, since it was established that with equal load current and equal duration, a regeneration of the contact surface 26 can possibly be greater at higher ambient temperatures. The ambient temperature can also be part of a table record, so that ultimately a characteristic map is provided for the surface regeneration parameter in dependence on the ambient temperature, the determined duration for which the contactor 20 is closed, and the determined load current.

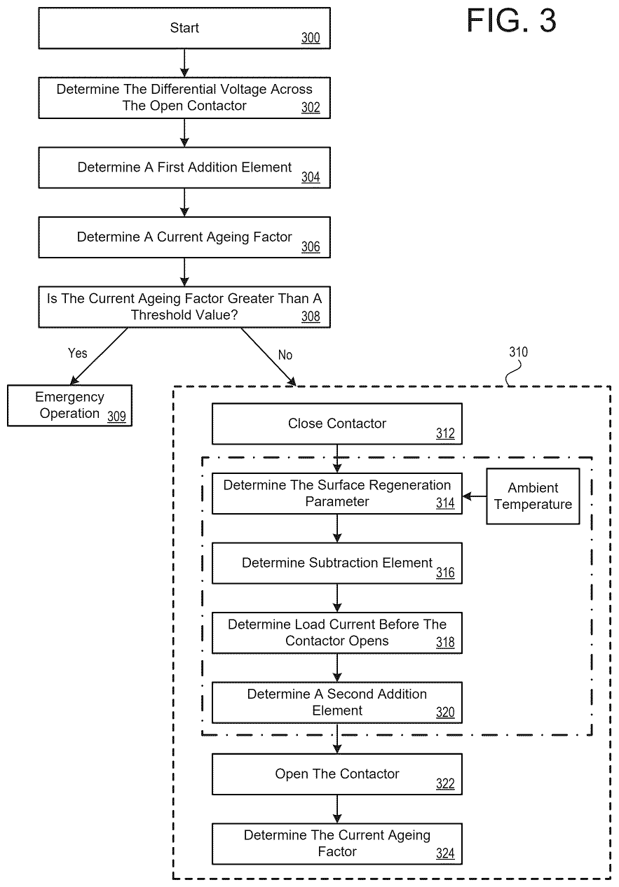

The surface regeneration parameter thus determined can now also be taken into account in the determination of an ageing factor of the contact surface 26 of the contactor 20, as described in more detail hereinafter in conjunction with FIGS. 3 to 5.

The method of FIG. 3 is used to determine an ageing factor of the contact surface 26 of the contactor 20. The ageing factor is representative of an ageing state of the contact surface 26 of the contactor 20 and is essentially a progressive counter, the value of which is changed in dependence on opening and closing of the contactor 20. The ageing factor can thus be increased, for example, when the contactor 20 is opened or closed. However, the ageing factor can also be reduced by a predetermined value. This is the case specifically when ultimately no ageing of the contact surface 26 takes place at all, but rather the opposite of ageing takes place, namely a surface regeneration of the contact surface 26. The term “ageing” means, for example, a roughening or a material removal or an erosion of the contact surface 26. This erosion of the contact surface 26 can take place in that arcs arise between contact surfaces 26 due to the high electrical powers which the contactor 20 has to conduct and material removals take place on the contact surfaces 26. Material removals on the contact surface 26 have the result that from a certain state, the functionality of the contactor 20 would possibly no longer be provided. The term “regeneration”, in contrast, refers to a self-healing of the contact surface 26, which takes place in the closed state of the contactor 20 under certain conditions, in particular in dependence on the load current and in dependence on the duration for which the contactor 20 is closed. The regeneration of the contact surface 26 results in at least partial smoothing of the contact surface 26, and thus acts against the process of erosion, hence also the term self-healing. The smoothing of the contact surface 26 takes place, for example, in that with corresponding load current over a corresponding duration, the contact surface 26 is heated and is thus automatically smoothed.

The method for determining the ageing factor of the contactor 20 starts with step 300.

In step 302, the differential voltage across the open contactor 20 is determined. This determination takes place via the two voltmeters 22, 24, which were described in conjunction with FIG. 1.

Based on the determined differential voltage across the open contactor (step 302), a first addition element for the ageing factor is determined in step 304. The first addition element can be determined, for example, based on functional relationships or table values in dependence on the determined differential voltage.

In the next step 306, a current ageing factor is determined. The current ageing factor is an updated ageing factor. The current ageing factor results from the last current ageing factor before the closing of the contactor 20 and adding of the first addition element, which in turn reflects the ageing of the contact surface 26 that occurs due to closing of the contactor 20.

In the next step 308, it is checked whether the current ageing factor thus determined is greater than a threshold value. The threshold value can be, for example, an emergency operation threshold value. If the current ageing factor thus calculated is greater than the threshold value, emergency operation is triggered in step 309. The emergency operation can include, for example, that the vehicle in which the contactor 20 is installed is no longer permitted to drive. However, if it is determined in step 308 that the current ageing factor thus determined is not greater than the threshold value, the steps in the dashed box 310 are processed.

Within the box 310, initially the contactor 20 is closed in step 312. The closing of the contactor 20 contributes to the ageing of the contact surface 26 for the reasons already mentioned, where the current ageing state of the contact surface 26 then resulting is represented by the current ageing factor already determined in step 306.

In the next step 314, because the contactor 20 is closed and the above-mentioned regeneration processes of the contact surface 26 occur, the surface regeneration parameter is determined. The determination again takes place on the basis of the determination, already described in conjunction with FIG. 2, of the load current when the contactor 20 is closed, determination of the duration for which the contactor 20 is closed, and possibly an ambient temperature of the contactor 20.

In the next step 316, a subtraction element for the ageing factor is determined based on the determined surface regeneration parameter. The subtraction element can again be provided as table values in dependence on the surface regeneration parameter. The subtraction element for the ageing factor is a nominally positive value, but it will reduce the ageing factor, as will be shown later, since the subtraction element is subtracted from the last current ageing factor. The subtraction expresses that the current ageing state is partially or completely reset due to the mentioned surface regeneration, since self-healing of the contact surface 26 takes place with corresponding load current over a corresponding duration.

After the subtraction element has now been determined in step 316, in the next step 318, the load current is determined immediately before the contactor 20 is opened. The load current immediately before the opening of the contactor 20 will often be less than the load current during the duration for which the contactor 20 is closed. This is because upon opening of the contactor 20, the maximum load current, which is used, for example, to charge the energy storage unit 12 or is made available by the energy storage unit 12, is to be prevented from flowing via the contact surface 26 upon opening of the contactor 20. This is because this would contribute to disproportionately high erosion of the contact surface 26 which is undesirable and is to be avoided.

Based on the determination of the load current immediately before the opening of the contactor (see step 318), in step 320, a second addition element for the ageing factor is now determined. The second addition element, like the first addition element, contributes to the ageing of the contact surface 26. This is because erosion and thus ageing of the contact surface 26 can also take place upon the opening of the contactor 20 and the arc that may then occur on the contact surface 26.

In the next step 322, the contactor 20 is now opened.

In the following step 324, the current ageing factor is determined. The current ageing factor is an ageing factor which characterizes the ageing state after the closing and after the re-opening of the contactor 20. The current ageing factor is determined based on the last known ageing factor before the opening of the contactor 20 and adding of the second addition element and subtracting of the subtraction element. Since the last known ageing factor before the opening of the contactor 20 already takes into account the first addition element, in the course of a closing and subsequent opening of the contactor 20, ultimately both addition elements are thus added to the last known ageing factor before the last closing of the contactor 20 and additionally the subtraction element is subtracted. The current ageing factor thus determined therefore takes into account, on the one hand, the ageing of the contact surface 26 due to the closing and the opening of the contactor 20, but also takes into account a surface regeneration of the contact surface 26 which has taken place while the contactor 20 is closed.

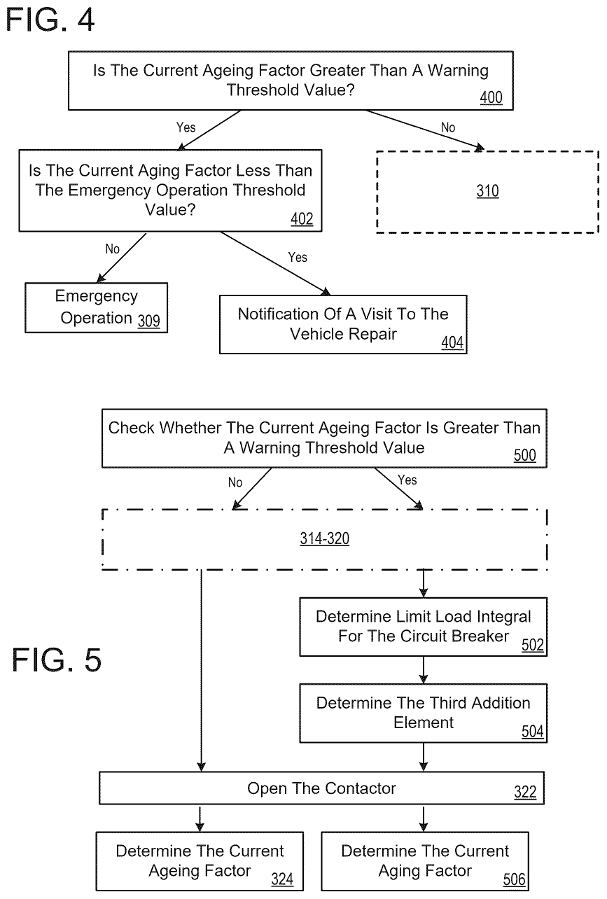

Reference is now made to FIG. 4, which shows an exemplary method of FIG. 3. As was already mentioned in conjunction with step 306 and 308 of FIG. 3, an ageing factor is calculated taking into account the first addition element and is compared to a threshold value.

As shown in FIG. 4, there are ultimately two threshold values. A warning threshold value and an emergency operation threshold value. The warning threshold value is below the emergency operation threshold value.

In step 400, which can follow step 308 or replace it, it is initially checked whether the current ageing factor determined in step 306 is greater than a warning threshold value. If this is not the case, thus if the warning threshold value is not exceeded, the steps which were described in conjunction with box 310 of FIG. 3 take place. However, if the result of step 400 is that the current ageing factor determined from step 306 is greater than said warning threshold, a query takes place in step 402 as to whether the current ageing factor is less than the emergency operation threshold value. If the query in 402 has the result that the ageing factor determined from step 306 is not less than the emergency operation threshold value, emergency operation of the vehicle takes place as was already described in conjunction with step 309. However, if the query in step 402 has the result that the current ageing factor determined in step 306 is less than the emergency operation threshold value, a communication about a vehicle repair shop visit for the surface regeneration of the contact surface 26 takes place in step 404.

Due to the two-step threshold value query according to FIG. 4, the emergency operation of the vehicle is thus ultimately not triggered immediately, but rather, if the current ageing factor is less than the emergency operation threshold value but greater than the warning threshold value, instead a communication is output that the surface regeneration of the contact surface 26 of the contactor 20 is possible, for example, by means of a vehicle repair shop visit.

Reference is now made to FIG. 5, which shows another exemplary method of FIG. 3.

As shown in FIG. 5, a short circuit, which has possibly taken place while the contactor 20 is closed, is checked.

For this purpose, it is initially determined in step 500 whether a short circuit has taken place in an electrical connection, such as in an electrical connection of the vehicle, while the contactor 20 is closed.

If no short circuit has taken place, ultimately steps 314 to 320 of the dot-dash box of FIG. 3 are executed, and the contactor 20 is also opened (step 322), and also the current ageing factor is calculated according to step 324 of FIG. 3.

However, if a short circuit, while the contactor 20 is closed, was determined in step 500, steps 314 to 320 are in fact processed first. In addition, however, in a step 502, the limit load integral is determined for the circuit breaker of the component in the vehicle which has interrupted the short circuit. Depending on which component in the vehicle has thus caused the short circuit, a different value of the limit load integral of the circuit breaker associated with the component results.

In step 504, a third addition element is determined based on the value of the limit load integral of the circuit breaker which has broken the short circuit. The third addition element can again be available based on table values or functional relationships in dependence on the determined value of the limit load integral.

As in the case of the non-occurring short circuit as well, the contactor 20 is now opened in step 322. In the following step 506, however, in comparison to step 324, the current ageing factor is taken into account while taking into account the third addition element, which was determined in conjunction with step 504. The difference in the calculation of the current ageing factor between steps 506 and 324 is therefore ultimately the third addition element, which takes into account the ageing of the contact surface 26 which has taken place due to the short circuit present in the closed state of the contactor 20.

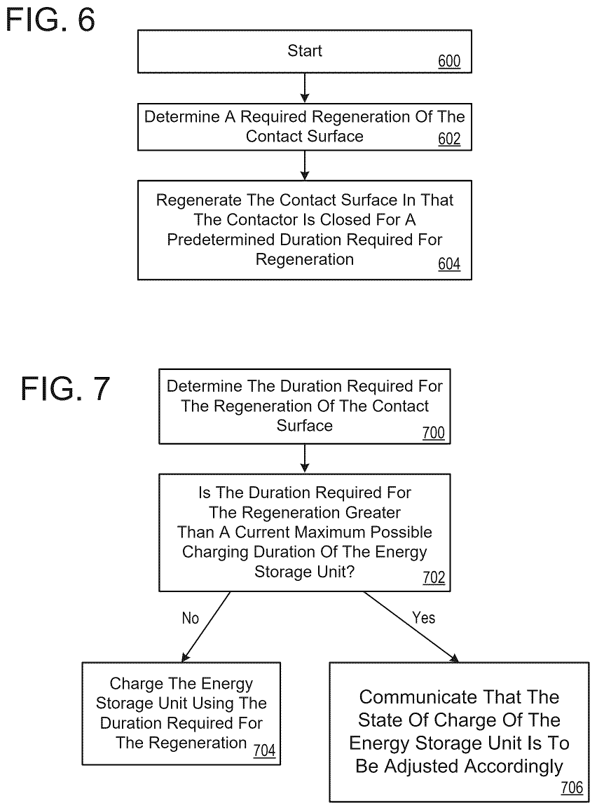

Reference is made to FIG. 6, which describes a further method that uses the knowledge of a possible regeneration of the contact surface 26 while the contactor 20 is closed.

Specifically, FIG. 6 describes a method for regenerating the contact surface 26 of the contactor 20, for example, in the electrical connection 10 of FIG. 1.

The method starts with step 600.

In step 602, a required regeneration of the contact surface 26 of the contactor 20 is determined. The required regeneration of the contact surface 26 can be determined, for example, in that the ageing factor exceeds a threshold value.

After the required regeneration has been determined in step 602, in following step 604, the contact surface 26 is regenerated in that the contactor 20 is closed for a predetermined duration which is required for the regeneration. The duration required for the regeneration of the contact surface 26 can again be produced based on table values and ultimately uses the relationship between load current, surface regeneration parameter, and possibly ambient temperature of the contactor 20, as has already been mentioned several times in conjunction with this disclosure.

Finally, reference is made to FIG. 7, which shows an example of the method from FIG. 6.

In FIG. 7, in a step 700, the duration required for the regeneration of the contact surface 26 is determined with reference to a load current determination with the contactor 20 closed.

In step 702, it is checked whether the duration required for the regeneration is greater than a current maximum possible charging duration of the energy storage unit 12 (see FIG. 1). If the duration required for the regeneration is not greater than the current maximum possible charging duration, which is determined in dependence on a current state of charge of the energy storage unit 12, in step 704, the energy storage unit 12 is charged using the duration required for the regeneration.

However, if it is determined in step 702 that the duration required for the regeneration is greater than the current maximum possible charging duration of the energy storage unit 12, in step 706, a communication takes place that the state of charge of the energy storage unit 12 is to be adjusted accordingly. In other words, the energy storage unit 12 has to be discharged more so that the maximum possible charging duration is increased. In particular, the maximum charging duration then possible has to be at least as long as the duration required for the regeneration. It is thus ensured that the energy storage unit 12 can be charged for a sufficiently long time in order to be able to carry out the required regeneration of the contact surface 26 during the charging of the energy storage unit 12.

A number of implementations have been described. Nevertheless, it will be understood that various modifications may be made without departing from the spirit and scope of the disclosure. Accordingly, other implementations are within the scope of the following claims.

What is claimed is:

1. A method for determining a surface regeneration parameter of a contact surface of an electrical contactor in a vehicle, wherein the surface regeneration parameter is representative of a regeneration of the contact surface of the contactor taking place during a closed state of the contactor, the method comprising:
determining a load current flowing through the closed contactor);
determining a duration in which the contactor is closed; and
determining the surface regeneration parameter based on the determined load current and the determined duration.

2. The method of claim 1, wherein the surface regeneration parameter is determined based on a load integral of determined load current and determined duration.

3. The method of claim 1, wherein the surface regeneration parameter is determined in dependence on an ambient temperature of the contactor.

4. A method for determining an ageing factor of a contact surface of an electrical contactor in a vehicle, wherein the ageing factor is representative of an ageing state of the contact surface of the contactor, wherein the ageing factor is a progressive counter, the value of which is changed in dependence on opening and closing of the contactor, the method comprising:
determining a differential voltage across the open contactor;
determining a first addition element for the ageing factor based on the determined differential voltage;
closing the contactor if a current ageing factor, which is calculated based on the last known ageing factor before the closing of the contactor and adding of the first addition element, is below a threshold value;
determining a surface regeneration parameter, which is representative of the regeneration of the contact surface of the contactor while the contactor is closed, wherein the surface regeneration parameter is determined based on a load current flowing through the closed contactor and a duration for which the contactor is closed;
determining a subtraction element for the ageing factor in dependence on the determined surface regeneration parameter;
determining the load current on the closed contactor immediately before the opening of the contactor;
determining a second addition element for the ageing factor based on the load current which was determined immediately before the opening of the contactor,
opening the contactor; and
determining a current ageing factor of the contactor after the opening of the contactor based on the last known ageing factor before the opening of the contactor and adding of the second addition element and subtracting of the subtraction element.

5. The method of claim 4, wherein the surface regeneration parameter is determined based on a load integral of determined load current and determined duration.

6. The method of claim 4, wherein the surface regeneration parameter is determined in dependence on an ambient temperature.

7. The method of claim 4, wherein, if a short circuit takes place in an electrical connection in the vehicle while the contactor is closed, the following steps are carried out:
determining the short circuit,
determining a value for the limit load integral of a circuit breaker which has interrupted the short circuit, and
determining a third addition element for the ageing factor based on the determined value for the limit load integral.

8. The method of claim 7, furthermore comprising:
calculating a current ageing factor, taking into account the short circuit, based on the last current ageing factor and adding the third addition element.

9. The method of claim 4, wherein, if the ageing factor after the adding of the first addition element exceeds a warning threshold value which is below an emergency operation threshold value, a communication about a vehicle repair shop visit for surface regeneration takes place.

10. A method for regenerating a contact surface of an electrical contactor in a vehicle, the method comprising:
determining that a regeneration of the contact surface is required; and
regenerating the contact surface by means of closing the contactor for a duration which is required for the regeneration.

11. The method of claim 10, wherein a load current flowing through the closed contactor is determined and the required duration for the regeneration is determined based on the determined load current.

12. The method of one of claim 10, wherein the contactor is arranged in an electrical connection between an energy storage unit of a vehicle and a charging unit for the energy storage unit and the regeneration of the contact surface takes place during the charging of the energy storage unit.

13. The method of claim 12, wherein, if the required duration is greater than a current maximum possible charging duration, which is determined in dependence on a current state of charge of the energy storage unit, a communication is issued according to which the state of charge of the energy storage unit is to be adapted accordingly.
